(19) United States
(12) Patent Application Publication
(10) Pub. No.: US 2017/0171509 A1
(43) Pub. Date: Jun. 15, 2017

(54) METHOD AND ELECTRONIC APPARATUS FOR REALIZING TWO-PERSON SIMULTANEOUS LIVE VIDEO

(71) Applicants: Le Holdings (Beijing) Co., Ltd., Beijing (CN); LE SHI INTERNET INFORMATION TECHNOLOGY CORP. BEIJING, Beijing (CN)

(72) Inventors: Shuo Huang, Beijing (CN); Xue Wu, Beijing (CN); Jiancheng Huang, Beijing (CN); Ruike Li, Beijing (CN)

(21) Appl. No.: 15/246,693

(22) Filed: Aug. 25, 2016

Related U.S. Application Data
(63) Continuation of application No. PCT/CN2016/088511, filed on Jul. 5, 2016.

(30) Foreign Application Priority Data
Dec. 14, 2015 (CN) 201510926097.3

(51) Int. Cl. H04N 7/14; G06F 3/0488

(52) U.S. Cl. CPC H04N 7/141; G06F 3/04883

(57) ABSTRACT

A method and a mobile client for realizing two-person simultaneous live video are provided in the disclosure. The method is adaptive to an inviter of two-person live video, and includes following steps: sending, in a first video window, a live broadcast invitation to an invitee, the first video window being provided by a first player; receiving live video data sent from the invitee and starting a second video window to play the live video data after receiving a response from the invitee, the second video window being provided by a second player; wherein the first video window and the second video window are displayed simultaneously, a size of the second video window is different from a size of the first video window.

### CROSS-REFERENCE TO RELATED APPLICATIONS

This application is a continuation of International Application No. PCT/CN2016/088511, filed on Jul. 5, 2016, which is based upon and claims priority to Chinese Patent Application No. 201510926097.3, titled “METHOD AND MOBILE CLIENT FOR REALIZING TWO-PERSON SIMULTANEOUS LIVE VIDEO”, filed on Dec. 14, 2015, the entire contents of which are incorporated herein by reference.

### TECHNICAL FIELD

The embodiments of the disclosure relate to smart application field, especially relate to a method and an electronic apparatus for realizing two-person simultaneous live video.

### BACKGROUND

Live video application, has been known by more people as a new internet social way, which is designed to provide convenient video sharing service for users anytime and anywhere.

In general, the live-video kind application is that, in a virtual room, an anchorperson records or plays videos, and other people watch the videos recorded or played by the anchorperson through the network. In other words, only single way live stream is achieved in the current live-video kind application. That is the form of one to many.

Additionally, in some slightly modified live-video kind application, the anchorperson can invite other people into the live show. However, the added live broadcast stream of new user will replace the original live broadcast stream. And after the end of the added live broadcast stream, the originally live broadcast stream continues to play.

That is, the way that the anchorperson is able to invite others to live show is actually a temporary replacement of anchorperson. It is still in the form of single way live stream, but no increase of the live stream.

Therefore, how to increase the live streams for realizing two-person simultaneous live video is a technical problem to solve urgently for person skilled in the art.

### SUMMARY

A method and an electronic apparatus for realizing two-person simultaneous live video are provided in the embodiments of the disclosure, used to solve the technical problem that, how to increase live streams for realizing two-person simultaneous live video, which is urgently to be solved for person skilled in the art.

In a first aspect, a method for realizing two-person simultaneous live video is provided in an embodiment of the disclosure. The method is adaptive to an inviter of two-person live video, and includes:

sending, in a first video window, a live broadcast invitation to an invitee, the first video window being provided by a first player; and

receiving live video data sent from the invitee and starting a second video window to play the live video data after receiving a response from the invitee, the second video window being provided by a second player;

wherein the first video window and the second video window are displayed simultaneously, a size of the second video window is different from a size of the first video window.

In a second aspect, a method for realizing two-person simultaneous live video is further provided in an embodiment of the disclosure. The method is adaptive to an invitee of two-person live video, and includes:

receiving, in a first video window, a live broadcast invitation from an inviter; starting a video capturing device to record live video data of an invitee and sending the live video data of the invitee to the inviter after sending a response to the live broadcast invitation; and

receiving live video data of the inviter, and starting a second video window to play the live video data of the inviter;

wherein the first video window and the second video window are displayed simultaneously, and a size of the first video window is different from a size of the second video window.

In a third aspect, a non-volatile computer storage medium is further provided in an embodiment of the disclosure, adaptive to an inviter terminal of the live video, wherein the computer storage medium stores computer-executable instructions, the computer-executable instructions are configured for carrying out any one of the mentioned above methods of the inviter of two-person live video for realizing two-person simultaneous live video.

In a fourth aspect, an electronic apparatus is further provided in an embodiment of the disclosure, adaptive to an inviter terminal of the live video, the electronic apparatus comprising:

at least one processor; and

a memory communicably connected with the at least one processor, wherein the memory stores instructions executable by the at least one processor, and execution of the instructions by the at least one processor causes the at least one processor to carry out any one of the mentioned above methods of the inviter of two-person live video for realizing two-person simultaneous live video.

In a fifth aspect, a non-volatile computer storage medium is further provided in an embodiment of the disclosure, adaptive to an invitee terminal of the live video, wherein the computer storage medium stores computer-executable instructions, the computer-executable instructions are configured for carrying out any one of the mentioned above methods of the invitee of two-person live video for realizing two-person simultaneous live video.

In a sixth aspect, an electronic apparatus is further provided in an embodiment of the disclosure, adaptive to an invitee terminal of the live video, the electronic apparatus comprising:

at least one processor; and

a memory communicably connected with the at least one processor, wherein the memory stores instructions executable by the at least one processor, and execution of the instructions by the at least one processor causes the at least one processor to carry out any one of the mentioned above methods of the inviter of two-person live video for realizing two-person simultaneous live video.

In the method and the electronic apparatus for realizing two-person simultaneous live video provided in the embodiments of the disclosure, in the case that the original live video is not affected in the live video broadcasting process, inviter sends a live broadcast invitation to the invitee. After invitee's agreement, a player is newly started to play live video picture of invitee to solve the technical problem that how to increase the live streams for realizing two-person simultaneous live video. In addition, windows of live video pictures of inviter and invitee are displayed, and the first video window and the second video window can be switched with each other, so that users can be purposeful to watch videos, and the user experience is further improved.

### BRIEF DESCRIPTION OF THE DRAWINGS

In order to illustrate the embodiments of the disclosure or technical solutions of conventional technique more clearly, simple introductions are provided for describing figures corresponding to embodiments or conventional technique. Obviously, the figures of the following description are some of the embodiments of the disclosure. For those of ordinary skill, other figures could be derived according to these figures without creative efforts.

FIG. 1 is a flow chart of a method for realizing two-person simultaneous live video in an embodiment of the disclosure.

FIG. 2 is a flow chart of another method for realizing two-person simultaneous live video in an embodiment of the disclosure.

FIG. 3 is a flow chart of another method for realizing two-person simultaneous live video in an embodiment of the disclosure.

FIG. 4 is a flow chart of another method for realizing two-person simultaneous live video in an embodiment of the disclosure.

FIG. 5 is a block diagram of a mobile client for realizing two-person simultaneous live video in an embodiment of the disclosure.

FIG. 6 is another block diagram of a mobile client for realizing two-person simultaneous live video in an embodiment of the disclosure.

FIG. 7 is another block diagram of a mobile client for realizing two-person simultaneous live video in an embodiment of the disclosure.

FIG. 8 is another block diagram of a mobile client for realizing two-person simultaneous live video in an embodiment of the disclosure.

FIG. 9 is another block diagram of a mobile client in an embodiment of the disclosure.

FIG. 10 is a hardware structure diagram block diagram of an electronic apparatus for realizing two-person simultaneous live video in an embodiment of the disclosure.

### DETAILED DESCRIPTION

In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

### Embodiment 1

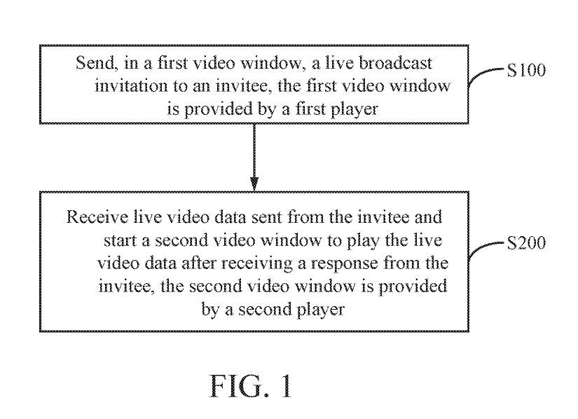

In order to solve the technical problem that how to increase live streams for realizing two-person simultaneous live video, a method for realizing two-person simultaneous live video is provided in the embodiment 1 of the disclosure, the method is adaptive to inviter (anchorperson) of two-person simultaneous live video. Here, the inviter is the anchorperson who is performing the live video broadcasting. The live video broadcasting is performed to audiences through a live video application. Another person, for realizing two-person live video is an invitee, may be an audience who receives the live video of inviter or another one who does not receive the live video of inviter, it is not limited thereto in the disclosure. Please refer to FIG. 1. FIG. 1 is a flow chart of a method for realizing two-person simultaneous live video in the embodiment 1 of the disclosure, and includes:

In the step S100: send, in a first video window, a live broadcast invitation to an invitee, the first video window is provided by a first player.

In the step S200: receive live video data sent from the invitee and start a second video window to play the live video data after receiving a response from the invitee, the second video window is provided by a second player. Wherein the first video window and the second video window are displayed simultaneously, a size of the second video window is different from a size of the first video window.

In the step S100, it is ensured first of all that, the inviter is performing the live video broadcasting. That is, the first video window provided by first player presents live video picture of the inviter, and live broadcast invitation is sent, in the first video window of the inviter, to invitee who is using live video application at the same time. Here, the invitee refers to the user who is using the live video application at the same time. The live broadcast invitation may be accompanied with prompt invitation in text form or audio form, etc. It should be noted additionally that, in practical applications, when the invitee who the inviter wants to invite does not use the live broadcast application, that is, when the main process of the live video application is not stated, a process which is configured for receiving the live broadcast invitation is automatically started in the device of the user to accept the live broadcast invitation. When receiving the live broadcast invitation, the main process of the live broadcast application is initiative to start. Thus, the scope of the invitees can be extended to the users who install the live broadcast application able to automatically start the process for receiving the live broadcast invitation.

Following the step S100 mentioned above, in the step S200, after the inviter receives the response of the live broadcast invitation from the invitee, that is, after the invitee agrees to join the live video, a second player is started additionally to perform the live video broadcasting to the invitee. It should be noted here that, before the second player is started to perform the live video broadcasting to the invitee, the inviter is already in the state of live video. That is, the interface of the inviter's live broadcast application has started the first player to play themselves' live video picture. Therefore, it is to start the second player additionally to perform the live video broadcasting to the invitee. That is, at this time, two players are started simultaneously in the inviter's live broadcast application. Each player provides one video window. The two video display windows displayed simultaneously are the first video window and the second video window, which display live video pictures of inviter and invitee, respectively. Wherein the first video window and the second video window are displayed at the same time, and the size of the second video window is different from the size of the first video window. In general case, the second video window which displays the live video picture of the invitee overlays the first video window which displays the live video picture of the inviter. And the size of the second video window is smaller than the size of the first video window. In other words, the invitee's live video picture is generally smaller and suspended above the inviter's live video picture, so as to show a “picture in picture” visual effect.

In the case that the original live video is not affected in the live video broadcasting process, inviter sends a live broadcast invitation to the invitee, and after invitee's agreement, a player is newly started to play live video picture of invitee to solve the technical problem that how to increase the live streams for realizing two-person simultaneous live video. In addition, the two-person live broadcast form of “picture in picture” has effect to improve the user experience.

In the excellent embodiments, the live video picture of the invitee is the second video window, and is able be dragged to arbitrary positions in the live video picture of the inviter, changed the size and the ratio thereof (the size refers to the size of the screen, such as 1.5 inches, 2 inches 2.5 inch, and the ratio generally refers to aspect ratio of the picture, such as 4:3, 16:9, etc.), and adjusted the video quality thereof (Smooth, Standard-Definition, High-Definition, etc.), etc.

Further, in other preferred embodiments of the disclosure, the second video window and the first video window can be switched with each other. That is, the video windows of the invitee and the live video picture of the inviter can be switched with each other in the interface of the live video application. Here, the live video picture of the inviter and the video window of the invitee can be switched with each other. In particular, video switching options can be set in the live video window which is below the video picture of the inviter. The users of the live video application can switch the picture to watch according to their own needs. It should be noted that, in general, the live video picture of the inviter is displayed in a larger picture. The video window, which is the live video picture of the invitee, is displayed in a small picture. The interactive switching mentioned above between the live video picture of the inviter and the video window which is the live video picture of the invitee is adaptive to the inviter's live broadcast application interface, also adaptive to the invitee's the live broadcast application interface, and further adapted to the audiences' live broadcast application interfaces.

As described above, the second video window and the first video window can be switched with each other, and it facilitates users to be purposeful to watch videos, and the user experience is further improved.

### Embodiment 2

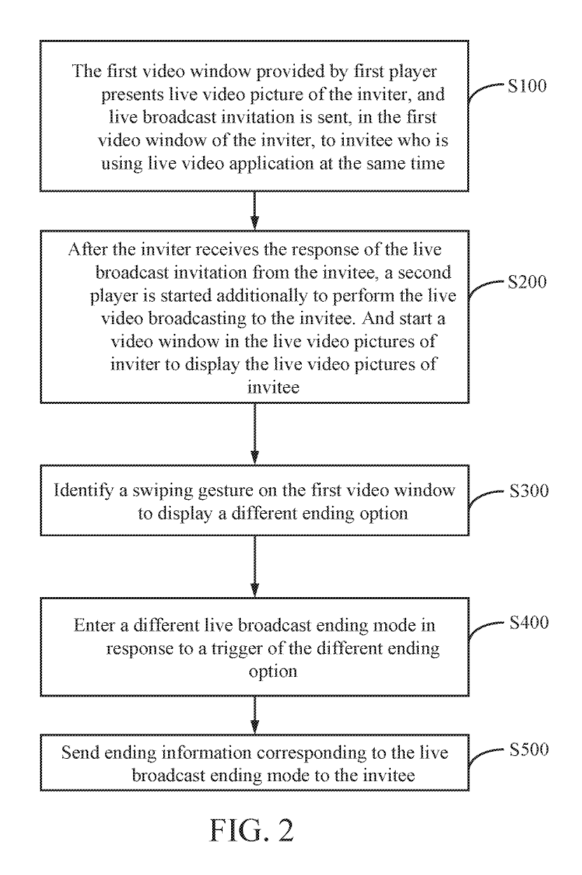

Please refer to FIG. 2, the embodiment in based on the embodiment 1. After the embodiment 1, a method for realizing two-person simultaneous live video in the embodiment of the disclosure, further includes:

In the step S300, identify a swiping gesture in the first video window to display a different ending option.

In the step S400, enter a different live broadcast ending mode in response to a trigger of the different ending option.

In the step S500, send ending information corresponding to the live broadcast ending mode to the invitee.

In the step S300, the inviter draws a swiping gesture on an interface of the live video. Here, the swiping gesture is performed on the interface of the live video in progress, and its projection in the vertical direction is greater than its projection in the horizontal direction. Further, here the specific length that the swiping gesture is drawn is not limited. However, in order to avoid misuse such as point contact, etc., it is usually to set a lower threshold value, such as to set the lower limit threshold as 0.4 cm. After identifying the swiping gesture, different of ending options are displayed in the interface of the live video. It is conceivable that the different ending options may be presented in the form of a suspended window, and the played live video picture may still be behind the suspended window. In addition, the different of ending options includes a timing ending option and an instant ending option.

Following the step S300, in the step S400, in response to a trigger of the different ending option which performed by the inviter, the live video application enters a different live broadcast ending mode. The live broadcast ending modes include a timing ending mode and an instant ending mode. The live video application enters the instant ending mode in response to the instant ending option. Here, the timing ending mode may be to stop the live video in a specific time point or to stop the live video after a time period. The instant ending mode may be to stop the live video instantly.

Following the step S400, in the step S500, after the inviter triggers the different ending option, the ending information corresponding to the live broadcast ending mode is sent to the invitee. Here, the ending information may be sent accompanied with a voice prompt or a text prompt, etc., to inform the invitee the coming live broadcast ending mode of the video, such as the timing ending mode and the instant ending mode, to facilitate the invitee to prepare.

The examples mentioned above are merely several kinds of realization forms of the disclosure. It is conceivable that other multiple realization forms are able to be derived according to conception of the disclosure. It can be realized that the other multiple realization forms also belong to the category of the disclosure and are within the scope of the disclosure.

### Embodiment 3

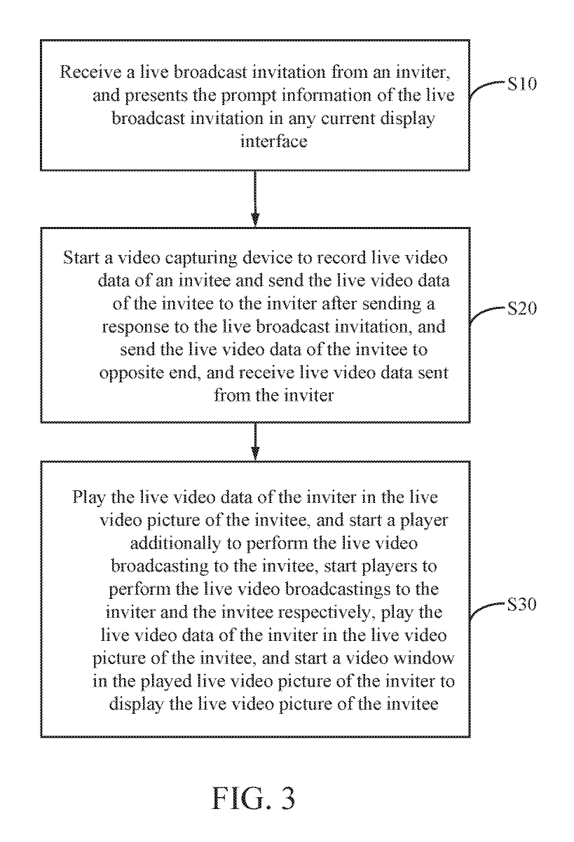

In order to solve the technical problem that how to increase live streams for realizing two-person simultaneous live video, a method for realizing two-person simultaneous live video is provided in the embodiment 3 of the disclosure, the method is adaptive to invitee (anchorperson) of two-person simultaneous live video. Here, the inviter is the anchorperson who is performing the live video broadcasting. The live video broadcasting is performed to audiences through a live video application. Another person, for realizing two-person live video is an invitee, may be an audience who receives the live video of inviter or another one who does not receive the live video of inviter, it is not limited thereto in the disclosure. Please refer to FIG. 3. FIG. 3 is a flow chart of a method for realizing two-person simultaneous live video in the embodiment 3 of the disclosure, and includes:

In the step S10, receive, in a first video window, a live broadcast invitation from an inviter.

In the step S20, start a video capturing device to record live video data of an invitee and send the live video data of the invitee to the inviter after sending a response to the live broadcast invitation.

In the step S30, receive live video data of the inviter, and start a second video window to play the live video data of the inviter. Wherein, the first video window and the second video window are displayed simultaneously, and a size of the first video window is different from a size of the second video window.

In the step S10, the live broadcast invitation from the inviter is received in the first video window. Here, the inviter refers to the user who is performing the live video broadcasting at the same time. The live broadcast invitation may be accompanied with prompt invitation in text form or audio form. The invitee shows the prompt information of the live broadcast invitation in current any display interface, such as the interface of the live video application, or other interfaces. In the other interfaces, the process which is used for receiving the live broadcast invitation in the live broadcast application of the invitee's device is necessary to be in a started state, and after receiving the live broadcast invitation, the main process of the live broadcast application is initiatively aroused. The presentation of the prompt information can be in the form of an information frame, to play a role that prompting the user.

Following the step S10 mentioned above, in the step S20, for realizing two-person live video, the invitee agrees to join the inviter live video event in responses to the live broadcast invitation. The invitee starts the video capturing device to perform video recording of the live video broadcasting data of the invitee. The video capturing device may be a camera or another device having an imaging function. The video capturing device is used for performing video recording to the invitee. The invitee sends the live video data recorded by the video capturing device to the inviter. It is conceivable that the live video data recorded by the video capturing device is also able to be sent to audiences who are watching the live video picture of the inviter. Wherein the steps of, recording live video data by the video capturing device and sending the live video data, are performed synchronously. Further, the invitee receives live video data sent from the inviter. Here, the invitee is an audience of the inviter, that is, the received live video data which is sent from the inviter already exists prior to this. If the invitee is not the audience of the inviter, or the invitee does not start the live video application previously, when the live video data of the invitee is sent, the live video data sent from the inviter is also received at the same time. That is, the invitee may be the audience of the inviter, another person who starts the live video application or the user who does not perform the live video application but starts the process for receiving the live broadcast invitation.

Following the step S20 mentioned above, in the step S30, live video data of the inviter is received, and a second video window is started to play the live video data of the inviter. That is, a second player is started in the first video window to play the live video data of the inviter, and a second video window is formed accordingly. The first video window is already started before receiving the live broadcast invitation (that is, a player is already started), and then a second video window is newly started (that is, another player is newly started). The two players form two video windows. The two video windows are not affected by each other, and display the live video picture of the inviter and the live video picture of the invitee, respectively. Wherein the first video window and the second video window display at the same time, and the size of the second video window is different from the size of the first video window. In general case, the second video window which displays the live video picture of the invitee overlays the first video window which displays the live video picture of the inviter. And the size of the second video window is smaller than the size of the first video window. In other words, the invitee's live video picture is generally smaller and suspended above the inviter's live video picture, so as to show a “picture in picture” visual effect.

In the case that the original live video is not affected in the live video broadcasting process, inviter sends a live broadcast invitation to the invitee, and after invitee's agreement, a player is newly started to play live video picture of invitee to solve the technical problem that how to increase the live streams for realizing two-person simultaneous live video. In addition, the two-person live broadcast form of “picture in picture” has effect to improve the user experience.

In the excellent embodiments, the live video picture of the invitee is the second video window, and is able be dragged to arbitrary positions in the live video picture of the inviter, changed the size and the ratio thereof (the size refers to the size of the screen, such as 1.5 inches, 2 inches 2.5 inch, and the ratio generally refers to aspect ratio of the picture, such as 4:3, 16:9, etc.), and adjusted the video quality thereof (Smooth, Standard-Definition, High-Definition, etc.), etc.

Further, in other preferred embodiments of the disclosure, the second video window and the first video window can be switched with each other. That is, the video windows of the invitee and the live video picture of the inviter can be switched with each other in the interface of the live video application. Here, the live video picture of the inviter and the video window of the invitee can be switched with each other. In particular, video switching options can be set in the live video window which is below the video picture of the inviter. The users of the live video application can switch the picture to watch according to their own needs. It should be noted that, in general, the live video picture of the inviter is displayed in a larger picture. The video window, which is the live video picture of the invitee, is displayed in a small picture. The interactive switching mentioned above between the live video picture of the inviter and the video window which is the live video picture of the invitee is adaptive to the inviter's live broadcast application interface, also adaptive to the invitee's the live broadcast application interface, and further adapted to the audiences' live broadcast application interfaces.

### Embodiment 4

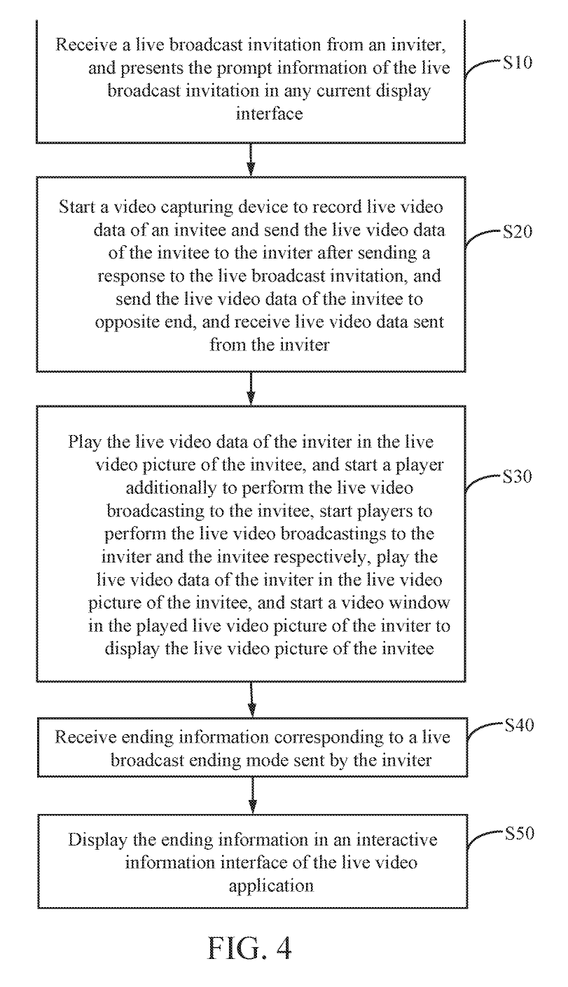

Please refer to FIG. 4, the embodiment in based on the embodiment 3. After the embodiment 3, a method for realizing two-person simultaneous live video in the embodiment of the disclosure, further includes:

In the step S40: receive ending information corresponding to a live broadcast ending mode sent by the inviter.

In the step S50: display the ending information in an interactive information interface of the live video application.

In the step S40, when the inviter is going to stop the live video event, the inviter sends ending information corresponding to the live broadcast ending mode to the invitee. The live broadcast ending modes include a timing ending mode and an instant ending mode. The live video application enters the instant ending mode in response to the instant ending option. Here, the timing ending mode may be to stop the live video in a specific time point or to stop the live video after a time period. The instant ending mode may be to stop the live video instantly. The invitee's live video application receives the ending information sent by the inviter, and the ending information is corresponding to the live broadcast ending mode. The way to receive may be in the interactive information interface of the live video application, and accompanied with a text prompt or a voice prompt, etc.,

Following the step S40 mentioned above, in the step S50, the ending information is displayed in the interactive information interface of the live video application. That is, the ending information is displayed in the interactive information interface of the live video application after the invitee's the live video application receives the ending information.

The ending information may prompt the invitee that what the live broadcast ending mode of the video is going to perform, such as the timing ending mode and the instant ending mode, to facilitate the invitee to prepare.

The examples mentioned above are merely several kinds of realization forms of the disclosure. It is conceivable that other multiple realization forms are able to be derived according to conception of the disclosure. It can be realized that the other multiple realization forms also belong to the category of the disclosure and are within the scope of the disclosure.

### Embodiment 5

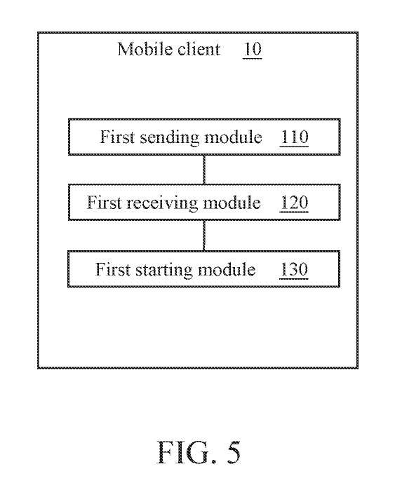

In order to solve the technical problem that how to increase live streams for realizing two-person simultaneous live video, a mobile client for realizing two-person simultaneous live video is provided in the embodiment of the disclosure, the mobile client is adaptive to inviter (anchorperson) of two-person simultaneous live video. Here, the inviter is the anchorperson who is performing the live video broadcasting. The live video broadcasting is performed to audiences through a live video application. Another person, for realizing two-person live video is an invitee, may be an audience who receives the live video of inviter or another one who does not receive the live video of inviter, it is not limited thereto in the disclosure. Please refer to FIG. 5, the mobile client 10 includes: a first sending module 110, a first receiving module 120 and a first starting module 130.

The first sending module 110 is configured for sending, in a first video window, a live broadcast invitation to an invitee, the first video window is provided by a first player.

The first receiving module 120 is configured for receiving a response from the invitee, and configured for receiving live video data sent from the invitee after receiving the response from the invitee.

The first starting module 130 is configured for starting a second video window to play the live video data, the second video window is provided by a second player, wherein the first video window and the second video window are displayed simultaneously, a size of the second video window is different from a size of the first video window.

In the case that the original live video is not affected in the live video broadcasting process, inviter sends a live broadcast invitation to the invitee, and after invitee's agreement, a player is newly started to play live video picture of invitee to solve the technical problem that how to increase the live streams for realizing two-person simultaneous live video. In addition, the two-person live broadcast form of “picture in picture” has effect to improve the user experience.

In other embodiments of the disclosure, the second video window and the first video window can be switched with each other.

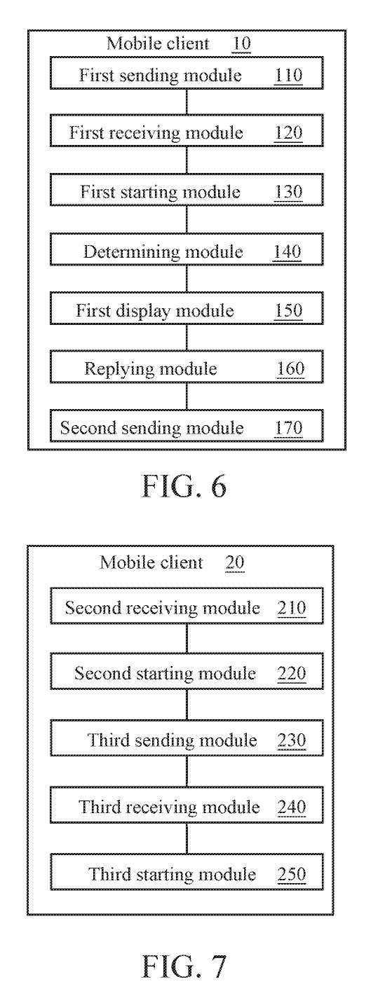

Please refer to FIG. 6. In other preferred embodiments of the disclosure, mobile client 10 further includes a determining module 140, a first display module 150, a replying module 160 and a second sending module 170.

The determining module 140 is configured for identifying a swiping gesture in the first video window.

The first display module 150 is configured for displaying a different ending option after the determining module identifies the swiping gesture.

The replying module 160 is configured for entering a different live broadcast ending mode in response to a trigger of the different ending option.

The second sending module 170 is configured for sending ending information corresponding to the live broadcast ending mode to the invitee.

### Embodiment 6

in order to solve the technical problem that how to increase live streams for realizing two-person simultaneous live video, a mobile client for realizing two-person simultaneous live video is provided in the embodiment of the disclosure, the mobile client is adaptive to invitee of two-person simultaneous live video. Here, the invitee receives invitation of live video from the inviter (anchorperson), for realizing two-person simultaneous live video. Please refer to FIG. 7, the mobile client 20 includes a second receiving module 210, a second starting module 220, a third sending module 230, a third receiving module 240 and a third starting module 250.

The second receiving module 210 is configured for receiving, in a first video window, a live broadcast invitation from an inviter.

The second starting module 220 is configured for starting a video capturing device to record live video data of an invitee after sending a response to the live broadcast invitation.

The third sending module 230 is configured for sending the live video data of the invitee to the inviter.

The third receiving module 240 is configured for receiving live video data of the inviter.

The third starting module 250 is configured for starting a second video window to play the live video data of the inviter, wherein the first video window and the second video window are displayed simultaneously, and a size of the first video window is different from a size of the second video window.

In the case that the original live video is not affected in the live video broadcasting process, inviter sends a live broadcast invitation to the invitee, and after invitee's agreement, a player is newly started to play live video picture of invitee to solve the technical problem that how to increase the live streams for realizing two-person simultaneous live video. In addition, the two-person live broadcast form of “picture in picture” has effect to improve the user experience.

In other embodiments of the disclosure, the second video window and the first video window can be switched with each other.

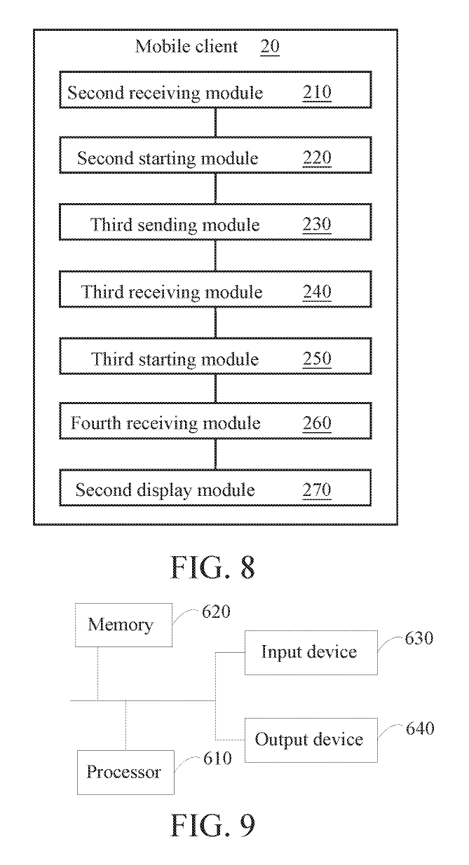

Please refer to FIG. 8. In other preferred embodiments of the disclosure, the mobile client 20 further includes a fourth receiving module 260 and a second display module 270.

The fourth receiving module 260 is configured for receiving ending information corresponding to a live broadcast ending mode sent by the inviter.

The second display module 270 is configured for displaying the ending information in an interactive information interface of the live video application.

It should be noted that, the embodiment 5 and the embodiment 6 of the devices mentioned above are described in perspectives of the inviter and the invitee of the mobile client mobile client for realizing two-person simultaneous live video, respectively. If there is any unclear description, please refer to the corresponding embodiments of the inviter and the invitee of the method for realizing embodiments of two-person simultaneous live video in the embodiments 1-4.

### Embodiment 7

The embodiment 7 of the disclosure further provides a non-volatile computer storage medium, adaptive to an inviter of the live video. The computer storage medium stores computer-executable instructions, and the computer-executable instructions can carry out any one of the mentioned above methods of the inviter of two-person live video for realizing two-person simultaneous live video.

### Embodiment 8

FIG. 9 is a hardware structure diagram of an electronic apparatus for realizing two-person simultaneous live video. As shown in FIG. 9, the electronic apparatus includes: one or more processor 610 and memory 620. FIG. 9 is an example of one processor.

The electronic apparatus for executing the method for realizing two-person simultaneous live video further includes: input device 630 and output device 640.

The processor 610, memory 620, input device 630 and output device 640 can be connected to each other via a bus or other means. In FIG. 9, they are connected to each other via the bus in this embodiment.

The memory 620 is one kind of non-volatile computer-readable storage mediums applicable to store non-volatile software programs, non-volatile computer-executable programs and modules; for example, the program instructions and the function modules (the first sending module 110, the first receiving module 120 and the first starting module 130 in FIG. 5) corresponding to the method for realizing two-person simultaneous live video in the embodiments are respectively a computer-executable program and a computer-executable module. The processor 610 executes function applications and data processing of the server by running the non-volatile software programs, non-volatile computer-executable programs and modules stored in the memory 620, and thereby the method for realizing two-person simultaneous live video in the aforementioned embodiments are achievable.

The memory 620 can include a program storage block and a data storage block, wherein the program storage block can store an operating system and at least one application program required for a function; the data storage block can store the data created according to the usage of the electronic apparatus for realizing two-person simultaneous live video. Furthermore, the memory 620 can include a high speed random-access memory, and further include a non-volatile memory such as at least one disk storage member, at least one flash memory member and other non-volatile solid state storage member. In some embodiments, the memory 620 can have a remote connection with the processor 610, and such memory can be connected to the electronic apparatus for realizing two-person simultaneous live video by a network. The aforementioned network includes, but not limited to, internet, intranet, local area network, mobile communication network and combination thereof.

The input device 630 can receive digital or character information, and generate a key signal input corresponding to the user setting and the function control of the electronic apparatus for realizing two-person simultaneous live video. The output device 140 can include a displaying unit such as screen.

The one or more modules are stored in the memory 620. When the one or more modules are executed by one or more processor 610, the method for realizing two-person simultaneous live video disclosed in any one of the embodiments is performed.

These products above can perform the method provided in the embodiments of the disclosure which is performed in client, and these products have corresponding function modules to perform the method and provide corresponding advantageous effects. The technical details which are not mentioned in this embodiment can be found in the method provided in the above embodiments.

### Embodiment 9

The embodiment 9 of the disclosure further provides a non-volatile computer storage medium, adaptive to an invitee of the live video. The computer storage medium stores computer-executable instructions, and the computer-executable instructions can carry out any one of the mentioned above methods of the invitee of two-person live video for realizing two-person simultaneous live video.

### Embodiment 10

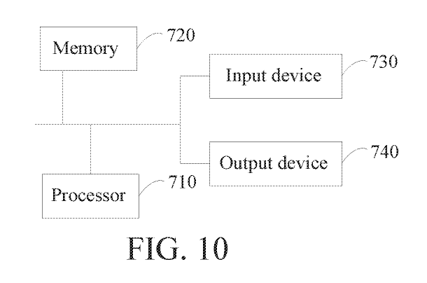

FIG. 10 is a hardware structure diagram block diagram of an electronic apparatus for realizing two-person simultaneous live video in an embodiment of the disclosure. As shown in FIG. 10, the embodiment of the disclosure further provides an electronic apparatus for realizing two-person simultaneous live video. The electronic apparatus includes:

one or more processor 710 and memory 720. FIG. 10 is an example of one processor.

The electronic apparatus for executing the method for realizing two-person simultaneous live video further includes: input device 730 and output device 740.

The processor 710, memory 720, input device 730 and output device 740 can be connected to each other via a bus or other means. In FIG. 10, they are connected to each other via the bus in this embodiment.

The memory 720 is one kind of non-volatile computer-readable storage mediums applicable to store non-volatile software programs, non-volatile computer-executable programs and modules; for example, the program instructions and the function modules (the second receiving module 210, the second starting module 220, the third sending module 230, the third receiving module 240 and the third starting module 250 in FIG. 7) corresponding to the method for realizing two-person simultaneous live video in the embodiments are respectively a computer-executable program and a computer-executable module. The processor 710 executes function applications and data processing of the server by running the non-volatile software programs, non-volatile computer-executable programs and modules stored in the memory 720, and thereby the method for realizing two-person simultaneous live video in the aforementioned embodiments are achievable.

The memory 720 can include a program storage block and a data storage block, wherein the program storage block can store an operating system and at least one application program required for a function; the data storage block can store the data created according to the usage of the electronic apparatus for realizing two-person simultaneous live video. Furthermore, the memory 720 can include a high speed random-access memory, and further include a non-volatile memory such as at least one disk storage member, at least one flash memory member and other non-volatile solid state storage member. In some embodiments, the memory 720 can have a remote connection with the processor 710, and such memory can be connected to the electronic apparatus for realizing two-person simultaneous live video by a network. The aforementioned network includes, but not limited to, internet, intranet, local area network, mobile communication network and combination thereof.

The input device 730 can receive digital or character information, and generate a key signal input corresponding to the user setting and the function control of the electronic apparatuse. The output device 740 can include a displaying unit such as screen.

The one or more modules are stored in the memory 720. When the one or more modules are executed by one or more processor 710, the method for realizing two-person simultaneous live video disclosed in any one of the embodiments is performed.

These products above can perform the method provided in the embodiments of the disclosure which is performed in client, and these products have corresponding function modules to perform the method and provide corresponding advantageous effects. The technical details which are not mentioned in this embodiment can be found in the method provided in the above embodiments.

The electronic apparatus in the embodiments of the present disclosure is present in many forms, and the electronic apparatus includes, but not limited to:

(1) Mobile communication apparatus: characteristics of this type of device are having the mobile communication function, and providing the voice and the data communications as the main target. This type of terminals include: smart phones (e.g. iPhone), multimedia phones, feature phones, and low-end mobile phones, etc.

(2) Ultra-mobile personal computer apparatus: this type of apparatus belongs to the category of personal computers, there are computing and processing capabilities, generally includes mobile Internet characteristic. This type of terminals include: PDA, MID and UMPC equipment, etc., such as iPad.

(3) Portable entertainment apparatus: this type of apparatus can display and play multimedia contents. This type of apparatus includes: audio, video player (e.g. iPod), handheld game console, e-books, as well as smart toys and portable vehicle-mounted navigation apparatus.

(4) Server: an apparatus provide computing service, the composition of the server includes processor, hard drive, memory, system bus, etc, the structure of the server is similar to the conventional computer, but providing a highly reliable service is required, therefore, the requirements on the processing power, stability, reliability, security, scalability, manageability, etc. are higher.

(5) Other electronic apparatus having a data exchange function.

The devices in the embodiments described above are merely illustrative. Wherein the units or modules described above as separate members may or may not be physically separated. The member as the unit or module may be or may not be a physical unit or module. That is, the member as the unit or the module may be located in a place, or may be distributed in a plurality of network units. A part or all of the unit or module can be selected to achieve the purpose of the embodiments according to the actual needs. The person having ordinary skill in the art can understood and implement according to the embodiments without making creative effort.

Through the above described embodiments, those skilled in the art can clearly understand that various embodiments may be accomplished through software incorporated a necessary universal hardware platform to achieve. Of course, it may also be accomplished through hardware. Based on this understanding, the above technical solution or the part of the contribution to the prior art may be substantially embodied in the form of software products. The computer software product may be stored in a computer-readable storage medium, such as ROM/RAM, disk, CD-ROMs, etc, and may include a number of instructions for making a computer device (may be a personal computer, server, or network device) to perform the various embodiments or portions of the described embodiments of the mentioned method.

Finally, it should be noted that: In order to present the purposes, technical solutions and advantages in the embodiments of the disclosure more clearly, the technical solutions in the embodiments of the disclosure as set forth below are described clearly and completely in conjunction with the accompanying drawings of the embodiments of the disclosure. It is obvious that the described embodiments are merely a part of the embodiments of the disclosure, but not all. Based on the embodiments of the disclosure, all other embodiments obtained by those of ordinary skill in the art without making creative efforts are also within the scope of the disclosure.

What is claimed is:

1. A method for realizing two-person simultaneous live video, adaptive to an inviter terminal of the live video, characterized by, comprising:
sending, in a first video window, a live broadcast invitation to an invitee, the first video window being provided by a first player; and
receiving live video data sent from the invitee and starting a second video window to play the live video data after receiving a response from the invitee, the second video window being provided by a second player;
wherein the first video window and the second video window are displayed simultaneously, a size of the second video window is different from a size of the first video window.

2. The method for realizing two-person simultaneous live video according to claim 1, characterized by, further comprising:
identifying a swiping gesture in the first video window to display a different ending option;
entering a different live broadcast ending mode in response to a trigger of the different ending option; and
sending ending information corresponding to the live broadcast ending mode to the invitee.

3. A method for realizing two-person simultaneous live video, adaptive to an invitee terminal of the live video, characterized by, comprising:
receiving, in a first video window, a live broadcast invitation from an inviter;
starting a video capturing device to record live video data of an invitee and sending the live video data of the invitee to the inviter after sending a response to the live broadcast invitation; and
receiving live video data of the inviter, and starting a second video window to play the live video data of the inviter;
wherein the first video window and the second video window are displayed simultaneously, and a size of the first video window is different from a size of the second video window.

4. The method for realizing two-person simultaneous live video according to claim 3, characterized by, further comprising:
receiving ending information corresponding to a live broadcast ending mode sent by the inviter; and
displaying the ending information in an interactive information interface of a live video application.

5. An electronic apparatus, comprising:
at least one processor; and
a memory communicably connected with the at least one processor, wherein the memory stores instructions executable by the at least one processor, and execution of the instructions by the at least one processor causes the at least one processor to:
send, in a first video window, a live broadcast invitation to an invitee, the first video window being provided by a first player; and
receive live video data sent from the invitee and starting a second video window to play the live video data after receiving a response from the invitee, the second video window being provided by a second player;
wherein the first video window and the second video window are displayed simultaneously, a size of the second video window is different from a size of the first video window.

6. The electronic apparatus according to claim 5, wherein the at least one processor is further caused to:
identify a swiping gesture in the first video window to display a different ending option;
enter a different live broadcast ending mode in response to a trigger of the different ending option; and
send ending information corresponding to the live broadcast ending mode to the invitee.
